(19) United States
(12) Patent Application Publication
(10) Pub. No.: US 2013/0113618 A1
(43) Pub. Date: May 9, 2013

(54) MULTIPATH TRANSPORT DATA AND CONTROL SIGNALING

(71) Applicants: Jessica M. Flanagan, Ashfield (AU); Craig W. Northway, Brisbane (AU); James S. Stewart, Austin, TX (US); Craig Brown, Harbord (AU); Michael W. Paddon, Tokyo (JP); James T. Ostrich, La Mesa, CA (US)

(72) Inventors: Jessica M. Flanagan, Ashfield (AU); Craig W. Northway, Brisbane (AU); James S. Stewart, Austin, TX (US); Craig Brown, Harbord (AU); Michael W. Paddon, Tokyo (JP); James T. Ostrich, La Mesa, CA (US)

(73) Assignee: QUALCOMM Incorporated, San Diego, CA (US)

(21) Appl. No.: 13/288,282

(22) Filed: Nov. 3, 2011

(51) Int. Cl. G08B 21/00; G08B 1/08

(52) U.S. Cl. 340/539.1; 340/686.1

(57) ABSTRACT

An example of a method for illuminating intelligent road markers to identify the location of a road user according to the disclosure includes: receiving a position identification message at a first intelligent road marker from a position identification unit associated with a road user; selecting one or more intelligent road markers proximate to the road user in response to the position identification message; and illuminating the selected one or more intelligent road markers to identify the presence of the road user on the road.

### BACKGROUND

Conventional road marking systems can make use of fixed road signs, portable signage, and non-interactive markings that are painted onto or affixed to the road. Electronic signage has been erected in some areas to provide information to road users, but these signs need to be programmed to provide information to road users. Furthermore, fixed signage needs to be permanently installed by a crew and portable signage requires a crew to install the signs in the field, and relocate or update the signs as work progresses on projects.

### SUMMARY

An example of a method for illuminating intelligent road markers to identify the presence of a road user on a road according to the disclosure includes: receiving a position identification message at a first intelligent road marker from a position identification unit associated with a road user indicating that the road user is present on the road; selecting one or more intelligent road markers proximate to the road user in response to the position identification message; and illuminating the selected one or more intelligent road markers to identify the presence of the road user on the road.

Implementations of such a method may include one or more of the following features. The method includes determining a direction of travel of the road user; and identifying one or more intelligent road markers in the direction of travel of the road user and one or more intelligent road markers behind the road user. Selecting one or more intelligent road markers proximate to the road user in response to the position identification message includes: selecting at least one of the one or more intelligent road markers in the direction of travel of the road user; and selecting at least one of the one or more intelligent road markers behind the road user. Determining a rate of travel of the road user; and the identifying one or more road markers in the direction of travel of the road user and one or more intelligent road markers behind the road user further includes: determining an illumination distance from the road user based on the rate of travel of the road user; and selecting intelligent road markers to be illuminated based on the illumination distance. The road user is a first road user and illuminating the selected one or more intelligent road markers proximate to the first road user is performed only if a second road user is detected within a predetermined distance of the first road user. Detecting the presence of the second road user comprises optically detecting the presence of the second road user. Detecting the presence of the second road user comprises detecting vibration induced by the second road user. Detecting the presence of the second road user at a second intelligent road marker; and transmitting a road user detected message from the second intelligent road marker to a plurality of intelligent road markers within a predetermined distance of the second intelligent road marker. The one or more intelligent road markers proximate to the first road user are illuminated if at least one of the one or more intelligent road markers proximate to the first road user receives the road user detected message.

An example of a dynamic intelligent road marker safety zone system according to the disclosure includes: a plurality of intelligent road markers deployed along a road surface, and each of the intelligent road markers includes: an illumination component; a wireless receiver configured to receive a presence indicator signal from a presence indication unit, the presence indication message indicates the presence of a road user proximate to the intelligent road marker; a controller configured to perform the operations of selecting one or more intelligent road markers proximate to the road user in response to the position identification message; and sending a control signal to the illumination component to illuminate in response to the presence indication message.

Implementations of such a dynamic intelligent road marker safety zone system may include one or more of the following features. The controller of each of the intelligent road markers are configured to perform operations of: determining a direction of travel of the road user; and identifying one or more intelligent road markers from the plurality of intelligent road markers that are located in the direction of travel of the road user and one or more road markers behind the direction of travel the road user. Each of the plurality of intelligent road markers includes a wireless transmitter configured to transmit illumination command messages wirelessly, and selecting one or more intelligent road markers proximate to the road user in response to the presence indicator signal further comprises: selecting at least one of the one or more intelligent road markers in the direction of travel of the road user, and selecting at least one of the one or more intelligent road markers behind the road user. Each of the intelligent road markers is configured to perform the operations of: determining a rate of travel of the road user; and wherein identifying one or more road markers in the direction of travel of the road user and one or more intelligent road markers behind the road user further comprises: determining an illumination distance from the road user based on the rate of travel of the road user; and selecting intelligent road markers to be illuminated based on the illumination distance. The road user is a first road user and illuminating the selected one or more intelligent road markers proximate to the first road user is performed only if a second road user is detected within a predetermined distance of the first road user. The intelligent road markers include at least one sensor for detecting the presence of a road user that does not have a position identification unit associated with the user. The at least one sensor includes an optical sensor for detecting the presences of the road user. The at least one sensor includes a motion vibration sensor to detect the presence of the road user. A second intelligent road marker is configured to: detect the presence of the second road user at a second intelligent road marker; and transmit a road user detected message from the second intelligent road marker to a plurality of intelligent road markers within a predetermined distance of the second intelligent road marker. The one or more intelligent road markers proximate to the road user are illuminated if at least one of the one or more intelligent road markers proximate to the road user receives the road user detected message.

An example of a dynamic intelligent road marker safety zone system according to the disclosure includes: means for receiving a position identification message at a first intelligent road marker from a position identification unit associated with a road user; means for selecting one or more intelligent road markers proximate to the road user in response to the position identification message; and means for illuminating the selected one or more intelligent road markers to identify the presence of the road user on the road.

Implementations of such a dynamic intelligent road marker safety zone system may include one or more of the following features. Means for determining a direction of travel of the road user, and means for identifying one or more intelligent road markers in the direction of travel of the road user and one or more intelligent road markers behind the road user. The means for selecting one or more intelligent road markers proximate to the road user in response to the position identification message further includes: means for selecting at least one of the one or more intelligent road markers in the direction of travel of the road user; and means for selecting at least one of the one or more intelligent road markers behind the road user. Means for determining a rate of travel of the road user. The means for identifying one or more road markers in the direction of travel of the road user and one or more intelligent road markers behind the road user further comprises: means for determining an illumination distance from the road user based on the rate of travel of the road user; and means for selecting intelligent road markers to be illuminated based on the illumination distance. The road user is a first road user and the means for illuminating the selected one or more intelligent road markers proximate to the first road user is illuminates the selected one or more intelligent road markers only if a second road user is detected within a predetermined distance of the first road user. The intelligent road markers include at least one means for detecting the presence of a road user that does not have a position identification unit associated with the road user. The means for detecting the presence of a road user that does not have a position identification unit associated with the road user includes means for optically detecting the presence of the road user. The means for detecting the presence of a road user that does not have a position identification unit associated with the road user includes means for detecting the presence of the road user via vibrations created by the road user. Means for detecting the presence of the second road user at a second intelligent road marker; and means for transmitting a road user detected message from the second intelligent road marker to a plurality of intelligent road markers within a predetermined distance of the second intelligent road marker.

An example of a tangible machine-readable medium having stored thereon machine-executable instructions for illuminating intelligent road markers to identify the location of a road user according to the disclosure includes: code for receiving a position identification message at a first intelligent road marker from a position identification unit associated with a road user; code for selecting one or more intelligent road markers proximate to the road user in response to the position identification message; and code for illuminating the selected intelligent road markers to identify the location of the road user on the road.

Implementations of such a tangible machine-readable medium may include one or more of the following features. Code for determining a direction of travel of the road user; and code for identifying one or more intelligent road markers in the direction of travel of the road user and one or more intelligent road markers behind the road user. The code for selecting one or more intelligent road markers proximate to the road user in response to the position identification message further comprises: code for selecting at least one of the one or more intelligent road markers in the direction of travel of the road user; and code for selecting at least one of the one or more intelligent road markers behind the road user. Code for determining a rate of travel of the road user; and the code for identifying one or more road markers in the direction of travel of the road user and one or more intelligent road markers behind the road user further includes: code for determining an illumination distance from the road user based on the rate of travel of the road user; and code for selecting intelligent road markers to be illuminated based on the illumination distance. The road user is a first road user and the code for illuminating the selected one or more intelligent road markers proximate to the first road user includes code for illuminating the selected one or more intelligent road markers only if a second road user is detected within a predetermined distance of the first road user. Code for detecting the presence of a road user using on signals from an optical sensor. Code for detecting the presence of a road user using signals from a vibration sensor. Code for detecting the presence of the second road user at a second intelligent road marker; and code for transmitting a road user detected message from the second intelligent road marker to a plurality of intelligent road markers within a predetermined distance of the second intelligent road marker.

### BRIEF DESCRIPTION OF THE DRAWINGS

FIG. 1 is a diagram illustrating a dynamic intelligent road marker safety zone system deployed on a roadway;

FIG. 2 is a block diagram illustrating wireless intelligent road markers (WIRMs) deployed along a bicycle lane of a road;

FIG. 3 is a block diagram illustrating WIRMs deployed along a bicycle lane and along the center line of a road;

FIG. 4 is a flow diagram of a method for illuminating WIRMs proximate to a road user;

FIG. 5 is a flow diagram of a method for selecting which WIRMs should be illuminated that can be used in conjunction with the method illustrated in claim 6;

FIG. 6 is a flow diagram of another method for selecting which WIRMs should be illuminated that can be used in conjunction with the method illustrated in claim 6;

FIG. 7 is a flow diagram of a method for selecting WIRMs to be illuminated proximate to a road user;

FIG. 8 is a method for detecting a second road user using a WIRM and transmitting the location of the second road user to WIRMs in the area; and

FIG. 9 is a method for illuminating WIRMs proximate to a road user in cooperation with a gateway or traffic server.

### DETAILED DESCRIPTION

Systems and methods for providing an illuminated safety zone around a user a road are provided. Some road users are not very visible to motorists due to their size, the available lighting, and/or their unexpected presence of these road users. Some examples of people that may be on the road with motorists include cyclists, road workers, postal delivery people, pedestrians, and drivers who have experienced mechanical problems with their vehicle. The systems and methods disclosed herein provide for an illuminated safety zone surrounding a vulnerable road user that can alert motorists to the presence of a vulnerable user.

The system includes a plurality of wireless intelligent road markers (WIRMs) that are deployed along a road surface. For example, the WIRMs can be deployed along with or instead of painted lines on a road surface. The WIRMs include a light-emitting element, a processor, and a wireless transceiver for sending and receiving messages. The WIRMs can provide a visual warning to motorists of the presence of an unexpected road user by illuminating the light-emitting element. The light-emitting element can be configured to emit light of different colors and/or to flash in various patterns to alert road users to the presence of other road users and/or hazards.

The dynamic intelligent road marker safety zone system can eliminate or reduce the need for temporary infrastructure for alerting motorists of road works ahead. For example, ongoing road works typically have signage and lighting that must be erected around the section of road on which work is being done. The cost of this equipment can be quite expensive and its installation can be time consuming and costly. The system disclosed herein can be used to minimize the amount of signage and warning lighting that is required, and can also reduce the need to move signage and lighting around as the worker move to different locations along the road. The illuminated safety zone automatically provided by the system automatically moves with the road user. As the road works crew moves along the road, the WIRMs proximate to the crew would be illuminated to warn motorists of the crew's location. The system can be configured to adjust the type of illumination and the distance from the road user based on the type of road user.

While the various examples illustrated herein use the term “road” or “roadway,” the use of these terms is not intended to limit the use of these techniques to roads or roadways. The techniques described herein can be applied to other types of routes or thoroughfares, such as bicycle paths. The techniques described herein can be applied to tracks, such as those for light rail or tramways. For example, the illuminated marker systems described here could be used on light rail systems or tramways that could encounter pedestrian, bicycle, or other types of traffic or where work crews on the tracks and a visual warning of the presence of others on the tracks could provide the tram or train operators with a visual warning of the presence of others on the tracks.

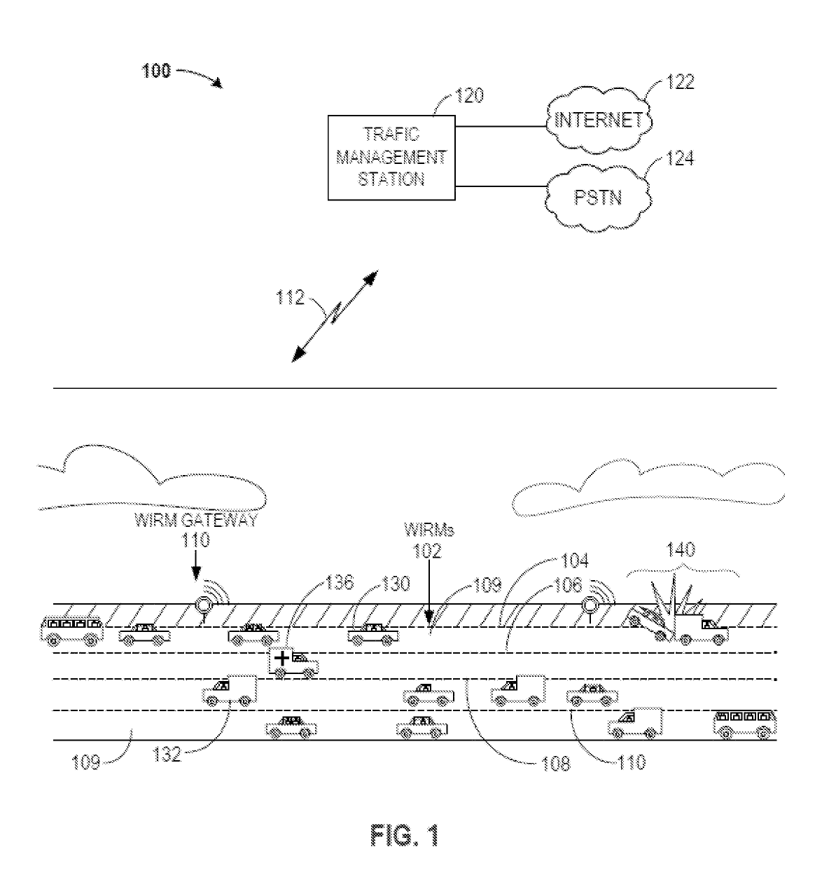

FIG. 1 illustrates an example of WIRMs 102 deployed along a roadway. FIG. 1 illustrates an example of a system in which the various techniques disclosed herein can be implemented. The system illustrated in FIG. 1 includes a plurality of WIRMs 102 deployed along road surface. The WIRMs 102 can be configured to communicate with a plurality of WIRM gateways 110 and a traffic management station 120. A WIRM 102 can wirelessly communicate with other WIRMs 102 proximate to the WIRM. The WIRMs 102 can also communicate with the traffic management station 120 via link 112. Traffic management station 120 and/or the WIRM gateways 110 can send commands to the WIRMs 102 to illuminate or turn off the illumination of the WIRMs' light emitting elements.

As can be seen in the example implementation illustrated in FIG. 1, a roadway having a plurality of lanes 109 is illustrated A plurality of cars 130, trucks 132, buses, motorcycles, bicycles, and other vehicles may be using the roadway. Each of the lanes 109 can have a corresponding group of WIRMS 104, 106, 108, and 110 that can be configured to illuminate in various colors and/or patterns to alert road users of road conditions. For example, the WIRMS 102 comprising the groups of WIRMs can be configured to illuminate in a specific color or colors and/or in a specific pattern to alert users of the road way of a road hazard, such as vehicle accident 140. The WIRMS 102 can also be configured to provide an illuminated safety zone surrounding vulnerable road users, such as pedestrian, postal workers, delivery people, slow moving or disabled vehicles, bicycles, road crews, or others that may be moving slowly or are stopped on the road surface.

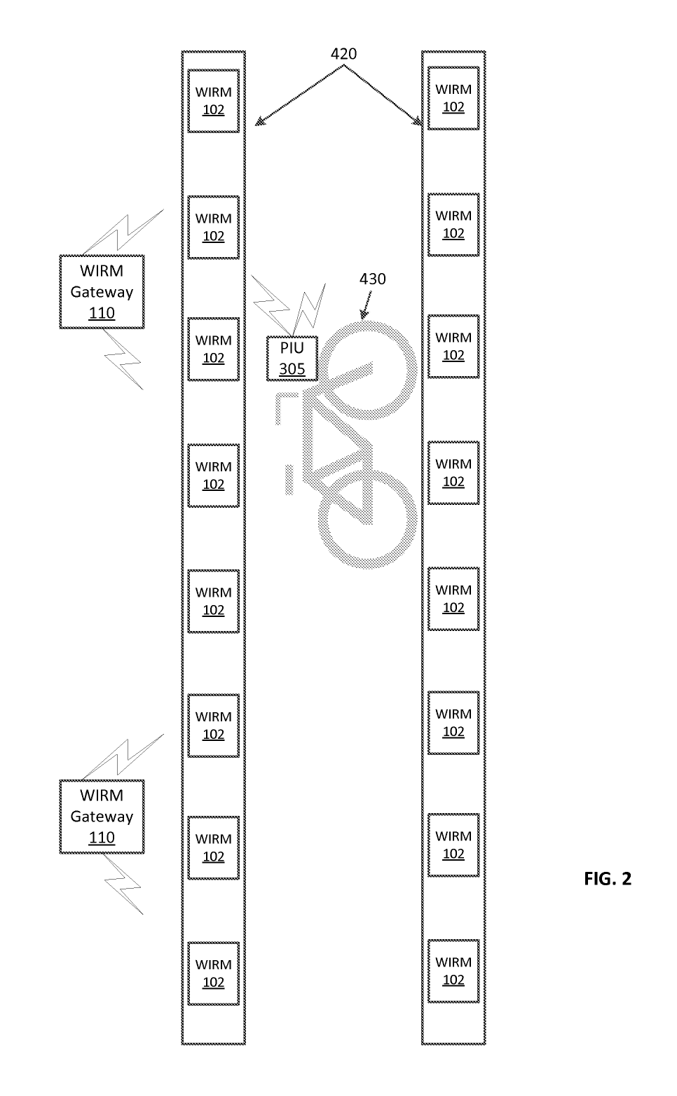

A WIRM 102 can be configured to communicate with other WIRMs in the general proximity of the WIRM. The WIRMs can also be configured to WIRM gateways and/or a central traffic management station. The example road marking systems illustrated in FIGS. 1 and 2 illustrate WIRM gateways 110 and central traffic management station 120. In some embodiments, the WIRMs can process information using onboard processors. In other embodiments, the WIRMs can send some or all information to the gateway and/or central traffic management station for processing. The WIRMs can be configured to operate as a self-organizing network using short range wireless transfer. An example of WIRMs being configured to form such a self-organizing network is disclosed in U.S. patent application Ser. No. 13/076,227 entitled “Communication of Emergency Messages with Road Markers”, which is hereby incorporated by reference in its entirety.

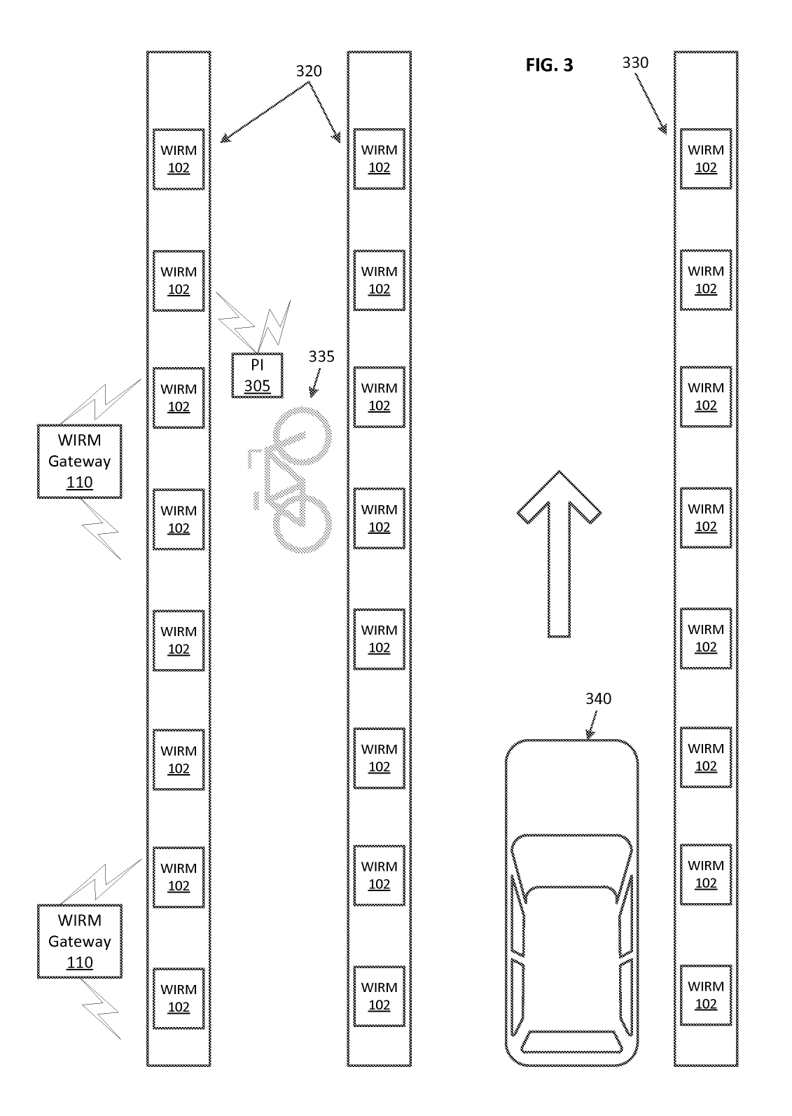

FIG. 3 illustrates an example where a cyclist is riding a bike 335 in a bike lane of a roadway. WIRMs 102 are included in the lane markings 320 that delineate the portion of the road that is allocated to the bike lane. The roadway also includes lane markings 330 that delineate a vehicle lane in which a car 330 is driving.

The WIRMs 102 can be configured to detect a presence indicator signal from a presence indicator unit (PIU) 305 associated with a road user. The PIU 305 is configured to transmit a presence indicator signal to the WIRMs 102 proximate to the bike. In some embodiments, the PIU 305 can be worn or carried by the rider of the bicycle. In other embodiments, the PIU 305 can be integrated into or affixed to the bicycle. The WIRMs 102 receiving the presence indicator signal 102 can then illuminate to provide a visible indicator of the position of the road user. As the bicycle continues along the bike lane, the WIRMs 102 proximate to the bicycle can be illuminated the illumination of those WIRMs from which the bicycle has moved away can be turned off. Thus, the WIRMs proximate to the position of the bike will provide an illuminated safety zone around the bicycle that notify other users of the road of the location of the bicycle.

The illumination of the safety zone can be triggered by the presence of a second user of the road approaching the road user that has the PIU. For example, FIG. 3 illustrates an example where a car 340 is approaching the location of the bicycle. As the car approaches the location of the bicycle, the WIRMs surrounding the bicycle can be illuminated to notify the driver of the car of the presence of the bicyclist in the bike lane. The car 340 can include a PIU to identify its presence to the WIRMs of the road marking system. However, the WIRMs can also be configured to identify vehicles that do not include a PIU. For example, WIRMs can be configured to identify the presence of a vehicle using sensors, such as optical sensors or vibration sensors incorporated into the WIRMs. The vibration sensors can detect vibrations induced by the presence of a road user. In other embodiments, the WIRMs can receive traffic information from external data sources. For example, the WIRM gateways 110 can be configured to receive traffic information from the traffic management station 120, and the WIRM gateway proximate to the location of the car 340 and/or the bicycle 335 can transmit position information to the WIRMs proximate to the bicycle 335 and/or the car 340 so the WIRMs proximate to the bicycle can be illuminated. Furthermore, WIRMs 102 proximate to the car 340 can also be illuminated to warn the driver of the vehicle that he or she is approaching the bicycle 335 even if the bicycle 335 may not yet be in visual range of the car. The WIRMs 102 can be configured to display a particular color pattern and/or flashing pattern based on the car's proximity the bicycle to give the driver of the car a visual indication of how close the car 340 is to the bicycle 335. Such an advance warning could be particularly useful if the vehicle is approaching the bicycle and the bicycle is located around a blind corner or over a hill from the car where the driver of the car cannot see the bicycle or in adverse weather conditions or darkness obscure the bicycle from the view of the driver of the car.

Vehicles can also be configured to interact with the WIRMs to provide information to the drivers of the vehicles and to increase the safety of the driver of the vehicles and other users of the road. For example, a vehicle can include a WIRM transceiver that can receive road layout information from the WIRMs and/or the WIRM gateways. FIG. 10, which is discussed in detail below, provides an example implementation of a WIRM transceiver 1000 that can be used to implement the technique disclosed herein. The WIRM transceiver can also be configured to transmit information to the WIRMs and/or the WIRM gateways. The WIRM transceiver can be configured to interface with various systems within the vehicle. For example, the road layout information can be displayed the driver of the vehicle on a heads-up display or other display device, such as the display of a navigation system included in the car. The WIRM transceiver can also be configured to interface with an autonomous cruise control system, an autonomous steering system, and/or other driver-assistance systems. The WIRM transceiver can also be configured to interface with one or more driver warning systems that can warn a driver of an upcoming hazard using audio and/or visual warnings.

The HUD can be used to display road layout information to the user and/or the location of hazards the roadway. This can be particularly useful in low visibility situations, such as nighttime and/or during adverse weather conditions such as rain, fog or snow that may negatively impact visibility of lane markings and/or road hazards.

The WIRM transceiver allows specific and dynamic information about the road to be transmitted to the vehicle. This system provides advantages over conventional systems where a control system on the vehicle is configured to interpret road conditions visually or through other means (e.g., radar). Furthermore, information about conditions outside of the visual range of the vehicle can be transmitted to the vehicle. Using the WIRMs to transmit the information to the WIRM transceiver on the vehicle provides an advantage over some conventional systems that provide sparsely distributed roadside transmitters. The communication with the vehicle allows for more specific warnings to be given to the driver (rather than just flashing IRMs or other similar visual indication on the road surface or on signs along the roadway).

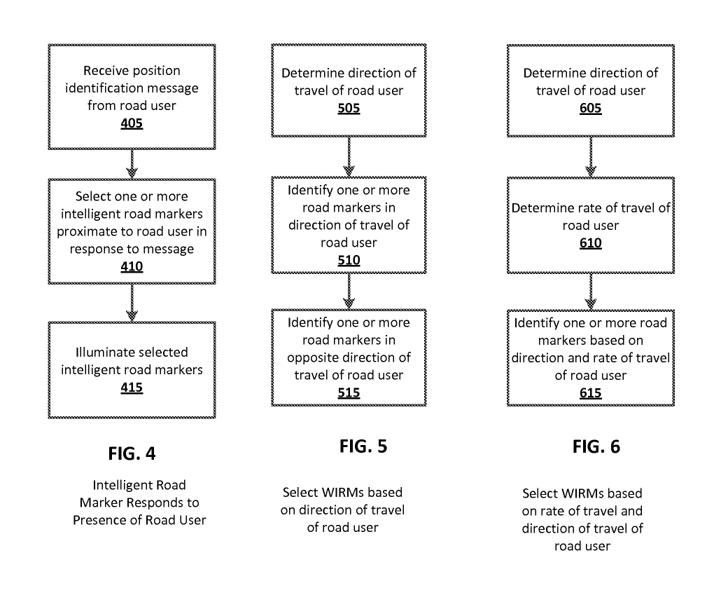

FIG. 4 is a block flow diagram of a method for illuminating WIRMs proximate to a road user. The method can be implemented by a plurality of WIRMs deployed along a roadway, path, driveway, or other surface where vehicular traffic (including automobiles, motorbikes, bicycles). For example, the method illustrated in FIG. 4 can be implemented by the dynamic road marker systems illustrated in FIGS. 1-3.

A position identification message is received at a WIRM 102 from a road user (stage 405). The presence indicator signal can be transmitted by a position identification unit 305. The PIU 305 can be implemented in a WIRM transceiver unit (WIU), such as the WIRM transceiver unit 1000 illustrated in FIG. 10. The PIU 305 can be configured to transmit a presence indicator signal that is recognized by the WIRMs to indicate that a road user is proximate to the one or more WIRMs receiving the presence indicator signal. The signal range of the PIU 305 can be limited to a relatively short distance, e.g. to a range within approximately 10 meters. In such an implementation, the road marker system could rely on the location of the WIRMs receiving the signals from the PIU 305 to determine the location of the road user that has the PIU 305. In other implementations, the PIU 305 can have a transmitter that is configured to transmit over a greater range, and the road marker system can be configured to determine the location of the PIU 305. For example, the road marker system could measure the relative signal strength of the presence indicator signal at the WIRMs 102 receiving the presence indicator signal to determine the location of the PIU 305.

The presence indicator signal can include information about the road user. For example, the presence indicator signal can identify the type of road user, such as pedestrian, bicyclist, car, truck, tractor trailer. The presence indicator signal can also include a unique identifier for the vehicle that can be associated with the vehicle license. The presence indicator signal can used this information can be passed on to emergency service vehicles. The information included in the presence indicator signal can include information that may be relevant to the road user or other road users. For example, the presence indicator signal may include information about the type of vehicle, the size of the vehicle, an estimated stopping distance for the vehicle, the speed and direction of travel of the road user, and/or other information.

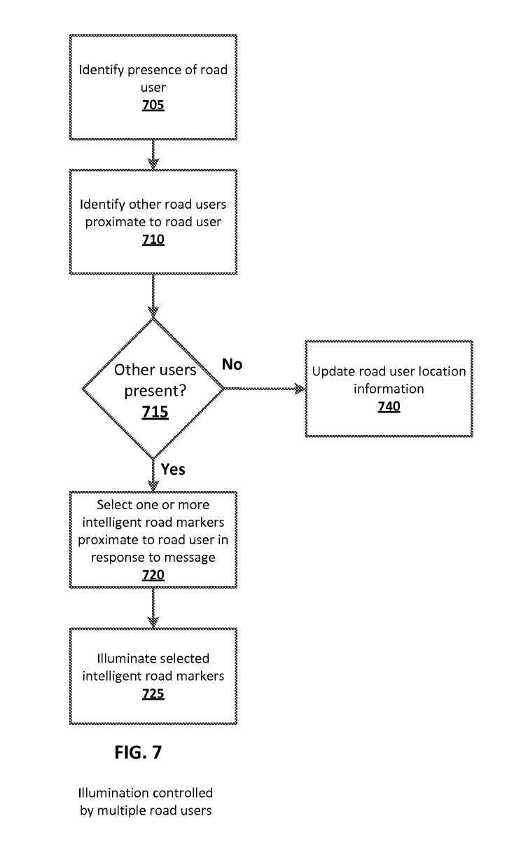

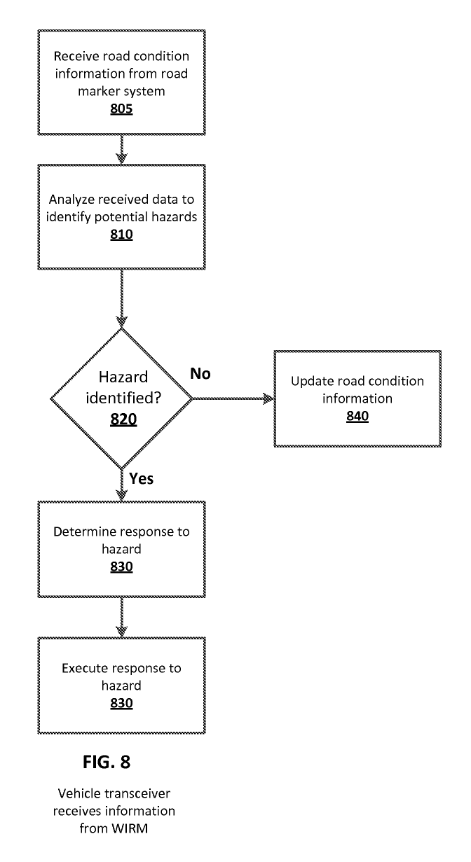

One or more WIRMs proximate to the road user can then be selected in response to receiving the presence indicator signal from the road user (stage 410). The WIRMs to be illuminated can be selected using various techniques described herein. For example, FIG. 5 illustrates a method for selecting WIRMs based on the position and direction of travel of the road user, and FIG. 6 illustrates a method for selecting WIRMs based on the position, direction of travel, and rate of travel of the road user. In some implementations, the location of the road user can be transmitted to a WIRM gateway 110 and/or to the traffic control station 120, and the traffic control station 120 or the WIRM gateway 110 can select the WIRMs to be illuminated based on the position of the road user and/or other information, such as rate and direction of travel of the road user. Other factors, such as the road conditions, such as a wet or icy road surface, and/or weather condition, such as darkness, overcast or foggy conditions, or rain, can be taken into account when selecting which WIRMs should be illuminated. For example, in adverse weather conditions, the WIRMs that are farther from the road user may be selected to provide other road users with more advance notice of the presences of the road user. The WIRMS can also be configured to establish a mesh network where WIRMs 102 proximate to one another can wirelessly communicate with one another and WIRMs 102 can communicate indirectly with other WIRMs that are part of the network by passing messages through the network to those WIRMs.

Once the WIRMs have been selected, an illumination command can be sent to each of the selected WIRMs 102 to illuminate a light-emitting element (stage 415). The command can include information that identifies which WIRMs are to be illuminated as well as colors and/or the pattern of illumination that each of the WIRMs should use. The command can originate at the traffic control station 120 or at a WIRM gateway 110. The command to illuminate the WIRMs can also originate from one of the WIRMs in the plurality of WIRMs. For example, the WIRMs can form a self-organizing mesh where one of the WIRMs 102 proximate to the road user is nominated as a “master” node that make a determination which WIRMs 102 proximate to the road user should be illuminated. The master node assignment can be updated periodically to nominate a new node proximate to the road user if the road user is moving along the roadway.

The WIRMs 102 can be configured to continue to monitor the position of the road user as the road user moves along the surface of the road. As the position of the road user changes, a different set of WIRMs 102 can receive the position identification message from the road user's PIU 350. As a result, a new set of WIRMs 102 can be selected to be illuminated and an illumination command can be sent to the new set of WIRMs 102 proximate to the new location of the road user. A command can be sent to those WIRMs that are no longer proximate to the road user instructing those WIRMs to turn off their light-emitting element.

FIG. 5 is a flow diagram of a method for selecting which WIRMS should be illuminated that can be used in conjunction with the method illustrated in claim 6. The method illustrated in FIG. 5 can be implemented by a WIRM 102, a WIRM gateway 110, the traffic control station 120, or a combination thereof.

The direction of travel of the road user is determined (stage 505). The direction of travel of the road user can be determined using various techniques. For example, if the position of the road user has been previously detected by one or more WIRMs 102, the direction of travel of the road user can be determined by comparing the road user's previous location to the road user's current location. If the road user is stationary, the current illumination state of the WIRMs proximate to the road user can be maintained and the direction of travel of the road user can be determined again after waiting for a predetermined period of time.

Once the direction of travel of the road user has been identified, one or more WIRMs that are in the direction of travel of the road user can be identified (stage 510). As a road user moves along the road surface, the road user may continue to approach new set of WIRMs 102 while leaving other set of WIRMs 102 behind the road user. A set of the WIRMs 102 that are in-front of and proximate to the road user can be selected in this stage to be illuminated.

One or more WIRMs that are the opposite direction of the road user can also be identified (stage 515). A set of the WIRMs 102 that are behind and proximate to the road user can be selected in this stage to be illuminated. The WIRMs that are identified in stages 510 and 515 can be illuminated with different color and/or illumination patterns to identify the direction of travel of the road user. For example, returning to the example illustrated in FIG. 3, the large arrow in the roadway indicates the direction of travel of both the bicycle 335 and the vehicle 340. A set of WIRMs that are located in front of the bicycle in the direction of travel of the bicycle may be illuminated using a first color and/or illumination pattern, while a second set of WIRMs behind the bicycle in the opposite the direction of travel may be illuminated using a second color and/or illumination pattern. The number of WIRMs 102 that are selected to be illuminated behind the road user can be different than the number of WIRMs 102 selected to illuminated before the road user. The number of WIRMs 102 that are selected can also be based on the direction and/or speed of travel of other road users proximate to the first road user.

In an example, the WIRMs 102 selected to be illuminated could be illuminated such that the WIRMs closest to the bicycle are brighter than those that are farther away from the bicycle to provide a visual indication of location of the bicycle to the driver of the vehicle 340. The WIRMS 102 can also be configured to use color to indicate the proximity of the WIRMs to the bicycle. In another example, WIRMs 102 that are farthest from the road user but within a predetermined distance from the road user might be illuminated using a first color (e.g. yellow) while WIRMs 102 whose distance from the road user fall within an intermediate range might be illuminated with a second color (e.g. orange), and WIRMs 102 that are closest to the road user than the intermediate range may be illuminated with a third color (e.g. red). Such a color gradient could provide a visual representation of location of the road user that could be used by other road users to estimate their proximity to the first road user.

The WIRM gateway 110 can be configured to keep track of which WIRMs 102 were previously illuminated proximate to a road user and can send a command to the WIRMs 102 that are no longer proximate to the road user to turn off their light-emitting element. The command to the WIRMs 102 to turn off the illumination of their light-emitting elements can also originate from one of the WIRMs in the plurality of WIRMs. For example, as described above, the WIRMs can form a self-organizing mesh where one of the WIRMs 102 proximate to the road user is nominated as a “master” node that make a determination which WIRMs 102 should turn off the illumination of the light-emitting elements. The master node assignment can be updated periodically to nominate a new node proximate to the road user if the road user is moving along the roadway.

FIG. 6 is a flow diagram of another method for selecting which WIRMS should be illuminated that can be used in conjunction with the method illustrated in claim 6. The method illustrated in FIG. 5 can be implemented by a WIRM 102, a WIRM gateway 110, the traffic control station 120, or a combination thereof.

The direction of travel of the road user is determined (stage 605). The direction of travel of the road user can be determined using various techniques. For example, if the position of the road user has been previously detected by one or more WIRMs 102, the direction of travel of the road user can be determined by comparing the road user's previous location to the road user's current location. If the road user is stationary, the current illumination state of the WIRMs proximate to the road user can be maintained and the direction of travel of the road user can be determined again after waiting for a predetermined period of time.

The rate of travel of the road user is also determined (stage 610). The rate of travel of the road user can be determined using various techniques. For example, the rate of travel of the road use can be determined based on how long it took the road user to travel from the road user's previously detected location to the road user's current location.

Identify one or more road markers based on direction and rate of travel of road user (stage 615). The number of WIRMs proximate to the road user to be illuminated can be selected based on the direction of travel and the rate of travel of the road user. For example, the faster that a road user is moving, the greater the number of WIRMs proximate to the road user that might be selected for illumination to provide a visual indicator of the road user's rate and direction of travel to other road users. The colors and/or the illumination pattern selected can also be based on the rate of travel of the road use to provide a visual indicator of the road user's rate and direction of travel to other road users. As described above with respect to FIG. 5, a set of WIRMs proximate to the road user that are in the direction of travel and a set of WIRMs proximate to the road user that are opposite the direction of travel can be selected and the illumination colors and illuminations patterns selected for each of these sets of WIRMs can be different.

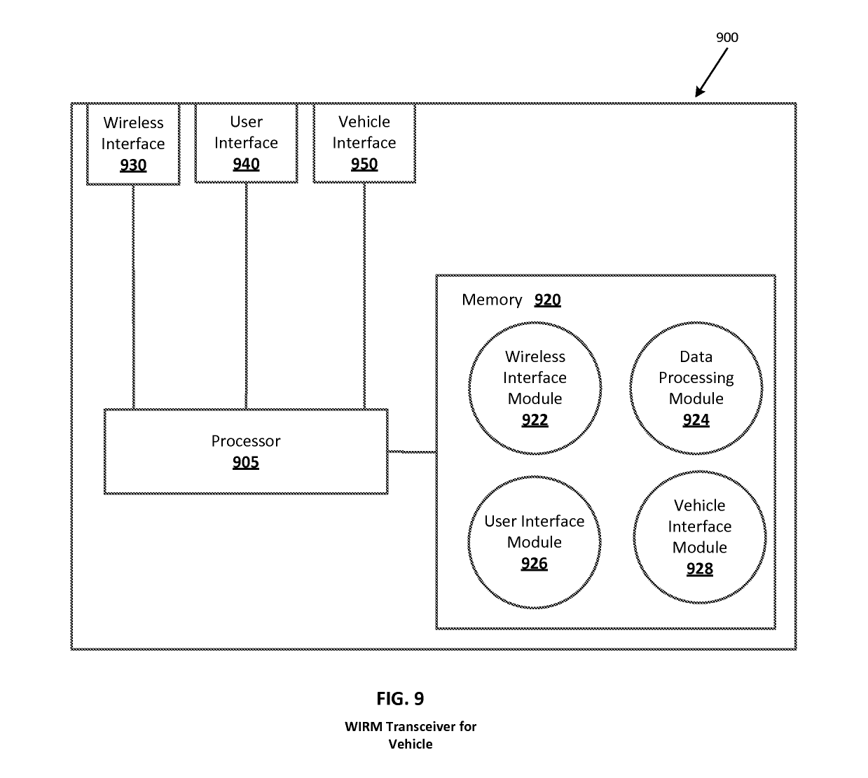

FIG. 7 is a flow diagram of a method for selecting WIRMs to be illuminated proximate to a road user. The method illustrated in FIG. 7 can be implemented by a WIRM 102, a WIRM gateway 110, the traffic control station 120, or a combination thereof In the method illustrated in FIG. 7, the presence of a first road user is identified and WIRMs proximate to the first road user and/or a second road user are selected and illuminated based on the presence of the two road users. The technique illustrated in FIG. 7 can be implemented by a first road marking systems described herein in locations where it is unnecessary or undesirable for the road markers proximate to a road user to be illuminated when no other road users are in the proximity of the first road user. For example, referring back to the example illustrated in FIG. 3. The WIRMs proximate to the bicycle 335 can be illuminated as the car 340 (or other road users) approach the location of the bicycle 335. This technique can be used to conserve battery power in the WIRMs 102 by only illuminating the WIRMs where there are multiple road users proximate to one another that could benefit from the information provided by the WIRMs 102.

The presence of a first road user is identified (stage 705). The presence of the first road user can be identified through various techniques. For example, the first road user can have a PIU that transmits presence indicator signal to the WIRMs 102 proximate to the road user. The presence of the road user can also be identified through sensors included in the WIRMs 102, such as a pressure or vibration sensors that can detect the presence of a road user. The vibration sensors can detect vibration induced by the motion of a road user. The road marker system can also be configured to only illuminate WIRMs proximate to a road user that has a PIU 305 and one or more WIRMs proximate to the road user receive a presence indicator signal from the road user's PIU 305. This configuration can be used to warn road users of disabled or slow moving vehicles (such as a snow plow or maintenance vehicle) or of the position of road works crews.

Other road users are proximate to the first road user can then be identified (stage 710). The WIRMs can be configured to send a user proximity request to the WIRM gateway 110 to determine whether any other users are proximate to the first user on the roadway. The WIRM gateway 110 can make a determination whether any other users are proximate to the first user on the roadway. The WIRM gateway 110 can also be configured to relay the user proximity request to the traffic management station 120, and the traffic management station 120 can make a determination whether there are any road users proximate to the first road user on the roadway. The WIRM gateways 110 and/or the traffic management station 120 can be configured to keep track of the positions of road users along the roadway. As can be seen in FIGS. 2 and 3, the WIRM gateways 110 can be deployed at various intervals along a roadway and can facilitate communications between the WIRMs 102 and the traffic management station 120. The WIRM gateways 110 can also be configured to receive information from the WIRMs and to send commands to the WIRMs to illuminate the light-emitting element of the WIRMs, to change the illumination pattern or color, and/or to turn-off the illumination.

The position of the first road user can be compared to the position of the second road user to determine whether one or more WIRMs 102 proximate to the first and/or the second road user should be illuminated. Whether two road users are proximate to one another can be a configurable parameter that depends on one or more parameters, such as the location of the first and second road users, the direction of travel of the first and second road users, the rate of travel of the first and second road users, and/or the road conditions. For example, if two road users are moving away from one another, the road marking system can be configured to not illuminate the road markers, because the first and second road users are not likely to encounter one another. In another example, the road marker system can be configured to increase the distance between road users in adverse weather conditions, such as fog, rain, or snow. The WIRMs can include moisture sensors, can be configured to receive weather information via a wireless connection (e.g., from the WIRM gateways 110 and/or the traffic management station 120).

A determination can then be made whether other road users are present proximate to the first road user (stage 715). If no other users are proximate to the road users, information about the first road user can be stored by the road marker system in a memory or data store accessible to the components of the road marker system (stage 740). For example, a WIRM gateway 110 and/or the traffic management station 120 can be configured to store information about the location and movement of road users along the roadway. The road markers system can use this stored to keep track of the presence of the first road users, and the information can be updated as the first road user moves along the roadway. The WIRMs 102 can detect whether the first road user has moved, the speed at which the first road users is moving, or whether the first road users has stopped moving and transmit that information to a WIRM gateway 110 or the traffic management station 120 which can then update the stored information for the first road user.

Otherwise, if a second road user is proximate to the first road user, one or more WIRMs 102 proximate to the first road user and/or the second road user can be selected to be illuminated (stage 720). The WIRMs to be illuminated based on the position of the road users and/or other information, such as rate and direction of travel of the road user. Other factors, such as the road conditions (wet, icy) and/or weather condition (dark, overcast, fog, rain) can be taken into account when selecting which WIRMs should be illuminated. For example, in adverse weather conditions, the WIRMs that are farther from the road user may be selected to provide other road users with more advance notice of the presences of the road user. The WIRMS can also be configured to establish a mesh network where WIRMs 102 proximate to one another can wirelessly communicate with one another and WIRMs 102 can communicate indirectly with other WIRMs that are part of the network by passing messages through the network to those WIRMs.

The road marker system can be configured to selectively illuminate WIRMs proximate to the first road user, the second road user, or both road users. The road marker system can be configured select WIRMs 102 proximate a road user that has a PIU 305. The road marker system can also be configured to select WIRMs 102 that are proximate to road users that do not have a PIU 305. The road marker system can be configured to base the determination whether to select WIRMs proximate to a road user, at least in part, on road conditions. For example, in adverse weather conditions, WIRMs 102 that are farther from the road user may be selected to provide other road users with more advance notice of the presences of the road user, and WIRMs 102 can be selected around a road user regardless of whether the road user has a PIU 305.

In some implementations, the road marker system can be configured to illuminate WIRMs 102 for all detected road users. For example, the WIRMs 102 can be deployed along a bicycle path through a park, and the WIRMs 102 proximate to all bicycles using the path can be illuminated. The road marker system can also be configured to select WIRMs to be illuminated that are proximate to all identified road users on certain segments of a roadway. For example, the road marker system can be configured that for a section of roadway that includes a blind corner or other features where visibility is limited can be configured to illuminate WIRMs proximate to all road users to provide the road users with a visual indication that other road users are nearby.

The selected WIRMs 102 can then be illuminated (stage 725). Once the WIRMs have been selected, an illumination command can be sent to each of the selected WIRMs 102 to illuminate a light-emitting element. The command can include information that identifies which WIRMs are to be illuminated as well as colors and/or the pattern of illumination that each of the WIRMs should use. The command can originate at the traffic control station 120 or at a WIRM gateway 110. The command to illuminate the WIRMs can also originate from one of the WIRMs in the plurality of WIRMs.

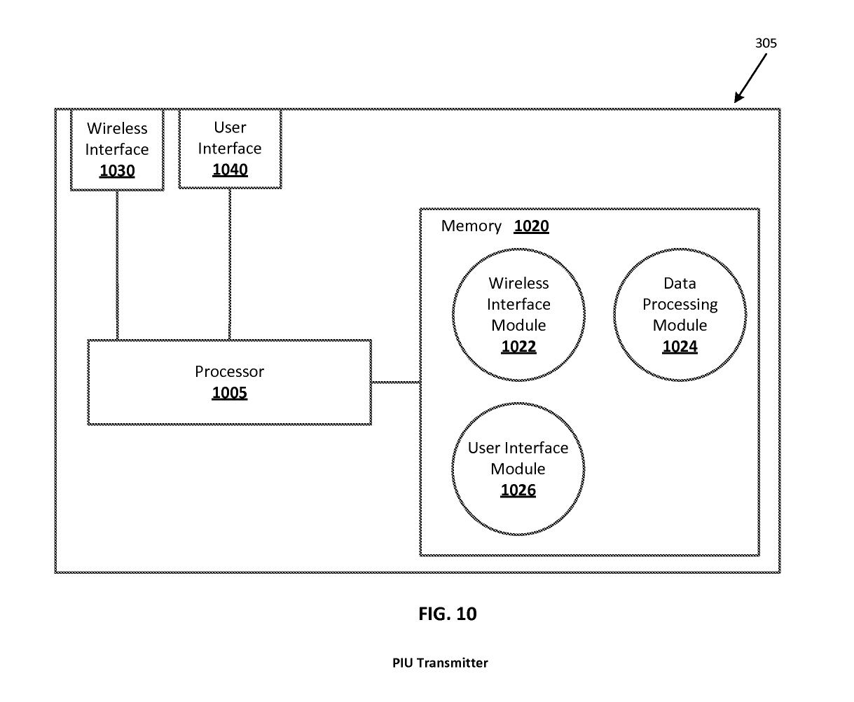

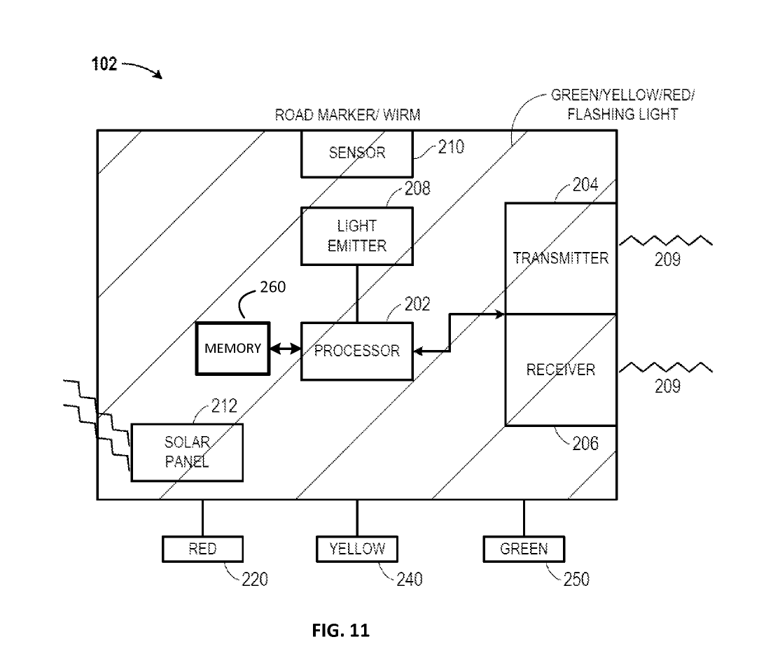

FIG. 8 is flow diagram of a method for reacting to road condition information obtained from road marker system. A vehicle can include a WIRM transceiver 900 that allows the vehicle to exchange information with the road marker system. An example of a WIRM transceiver is illustrated in FIG. 9. The WIRM transceiver can include a user interface, such as an audio or audiovisual interface that can present audio or visual content to a user regarding road conditions, hazards, and other information that may be of interest to a road user. The WIRM transceiver can include a vehicle interface that enables the WIRM transceiver exchange data with the vehicle and/or vehicle accessories. For example, the WIRM transceiver can interface with the sound system, navigation system, a heads-up display, or other interface of a vehicle to provide information to the road user regarding road conditions, such as traffic, road hazards, weather, and/or other information.

The WIRM transceiver of the vehicle can receive road condition information from road marker system (stage 805). The WIRM transceiver 900 can receive the road condition information from a WIRM 102 or a WIRM gateway 110 proximate to the vehicle. Both the WIRMs 102 and the WIRM gateways 110 include wireless transmitters that can be used to transmit condition information to road users.

The road condition information can then be analyzed to identify potential hazards (stage 810). The WIRM transceiver 900 can be configured to identify various types of hazards included in the road condition information, such as traffic-related hazards, such as vehicle breakdowns, stopped vehicles or slow vehicles ahead, and heavy traffic. The WIRM transceiver 900 can also be configured to identify road hazards, such as closed lanes, debris in the lanes, or road works. The WIRM transceiver 900 can also identify weather-related hazards, such as wet, foggy, or icy conditions.

The WIRM transceiver 900 can then make a determination whether one or more hazards were identified in the road condition information (stage 820). If no hazards were identified, the WIRM transceiver 90 can update the road condition information stored onboard the transceiver and/or provide an update (stage 840).

If one or more hazards have been identified in the road condition information, the WIRM transceiver 900 can determine a response to the hazard (stage 830). The WIRM transceiver 900 can include a database of responses to various types of hazards, and can select a response based on the type of hazard identified in the road condition information. For example, if the WIRM transceiver 900 determines that there is a traffic-related hazard, such as broken down vehicle, the WIRM transceiver 900 can provide an audible or visual warning to the driver of the vehicle. For example, in the WIRM transceiver 900 could display an icon or representation on a heads-up display, in dash video screen, or navigation system of the vehicle indicating that there is a disabled vehicle. The WIRM transceiver 900 can also identify the location of the disabled vehicle on a map and/or provide information regarding the vehicle's distance from the disable vehicle and/or which lanes of the roadway are affected. In another example, if the WIRM transceiver 900 determines that there is a road-related hazard, such as debris in a lane or lanes of the roadway, the WIRM transceiver 900 can provide an audible or visual warning to the driver of the vehicle. WIRM transceiver 900 could also display an icon or representation on a heads-up display, in dash video screen, or navigation system of the vehicle indicating that the vehicle is approaching the road hazard. The WIRM transceiver 900 can also identify the location of the road-hazard on a map and/or provide information regarding the vehicle's distance from the disable vehicle and/or which lanes of the roadway are affected. In yet another example, if the WIRM transceiver 900 determines that there is a weather-related hazard, such as ice, snow, or fog, the WIRM transceiver 900 can provide an audible or visual warning to the driver of the vehicle indicating that the vehicle is approaching a portion of roadway where adverse weather conditions are present.

The WIRM transceiver 900 can then execute response to hazard (stage 840). As described above, the response take can vary based on the type of hazard, and can include providing audiovisual feedback that can be displayed to the driver by the WIRM transceiver 900 or can be output by the WIRM transceiver 900 to be displayed to the driver by one or more vehicle accessories, such as heads-up display, navigation system, video screen, or audio system.

FIG. 9 is a block diagram of a WIRM transceiver 900 that can be included in a vehicle of a road user. The WIRM transceiver 900 can send and/or receive data from the road marker system. For example, the WIRM transceiver 900 can receive road condition information from regarding road conditions, road hazards, weather conditions, and other information that may be of interest to a road user. The WIRM transceiver can include a vehicle interface that enables the WIRM transceiver exchange data with the vehicle and/or vehicle accessories. For example, the WIRM transceiver can interface with the sound system, navigation system, a heads-up display, or other interface of a vehicle to provide information to the road user regarding road conditions, such as traffic, road hazards, weather, and/or other information. The WIRM transceiver 900 includes a processor 905, a memory 920, a wireless interface 930, a user interface 940, and a vehicle interface 950.

The processor 905 can comprise one or more microprocessors configured to access memory 920. The processor 905 can read data from and write data to memory 920. The processor 905 can also read executable program code from memory 920 and execute the program code.

The memory 920 includes a wireless interface module 922, a data processing module 924, a user interface module 926, and a vehicle interface module 928. The memory 920 can comprise one or more types of tangible, non-transitory computer-readable memory, such as random-access memory (RAM), read-only memory (ROM), flash memory, or a combination thereof. The modules can comprise processor-executable instructions that can be executed by processor 905.

Wireless interface 930 enables the WIRM transceiver 900 to wirelessly communicate with components of the road marker system, such as the WIRMs 102, WIRM gateways 110, and/or the traffic management station 120. The wireless interface module 922 can send data to and receive data from other components of the road marker system via the wireless interface 930. The wireless interface module 922 can provide data received by the wireless interface 930 to other modules in memory 920 for processing and can receive data from the other modules to be transmitted to other components of the road marker system using wireless interface 930.

User interface 940 can include one or more audiovisual components that allows the user to interact with the WIRM transceiver 940. For example, the user interface 940 can include display devices, touchscreens, audio speakers, keypads or keyboard, and/or other user interface components that can be used to present information to a user and/or receive input from the user. For example, the WIRM transceiver 940 can be configured to be a dash-mounted device that includes a display and/or audio speaker that can be used to present information about road conditions to the driver of the vehicle. In some implementations, the WIRM transceiver 490 can be integrated into a portable navigation device, such as a portable GPS receiver, or can be integrated into an in-vehicle navigation system that is installed in the vehicle. User interface module 922 can send information to be displayed by the user interface 940, and can generate a graphical user interface that can be displayed by the user interface 940.

Vehicle interface 950 can provide an interface between one or more systems incorporated into the vehicle and the WIRM transceiver 900. For example, the vehicle interface can provide an interface between WIRM transceiver 900 and the vehicle's navigation system or an audiovisual system included in the vehicle. For example, the vehicle interface 950 can provide an interface between the WIRM transceiver 900 and a heads-up display that can be used to display information to the driver of the vehicle. The vehicle interface module 928 can output data signals to one or more vehicle systems via the vehicle interface 950. The vehicle interface module 928 can receive instructions from the data processing module 924 to display content to the driver or play an audio message to the driver or provide feedback to the driver via one or more other vehicle user interface devices.

The data processing module 924 can be configured to analyze data received by the WIRM transceiver 900. Data can be received from the WIRMs 102, the WIRM gateways 110, and/or the traffic management station 120. The data processing module 924 can be configured to generate control signals that can control one or more user interface components via the user interface 940. The data processing module 924 can also be configured to generate control signals that send and/or receive data from one or more systems incorporated in the vehicle via the vehicle interface 950. The data processing module 924 can analyze data received from the WIRMs 102, the WIRM gateways 110, and/or the traffic management station 120, and/or vehicle systems to identify potential hazards, to determine a response to any identified hazards, and to execute the responses. For example, if the WIRM transceiver 900 receives road condition information from the WIRMs 102 that there is a disabled vehicle ahead in the lane in which the vehicle is traveling, the WIRM transceiver can determine an appropriate response, such as providing an audio warning instructing the driver to slow down or change lanes, and/or a visual warning displaying a representation of the disabled vehicle on a head-up display in the vehicle or on the display of the vehicle's navigation system.

FIG. 10 is a block diagram of a presence indicator unit (PIU) that can be used to implement the PIU 305 described above. As described above, the PIU 305 can be configured to transmit a presence indicator signal to the road marker system that identifies the presence of a road user. The presence indicator signal can be used by the road marker system to identify the presence of the road user and can be used when determining whether to illuminate one or more WIRMs 102 located proximate to the road user and/or other road users.

The processor 1005 can comprise one or more microprocessors configured to access memory 1020. The processor 1005 can read data from and write data to memory 1020. The processor 1005 can also read executable program code from memory 1020 and execute the program code.

The memory 1020 includes a wireless interface module 1022 and a data processing module 1024. The memory 1020 can comprise one or more types of tangible, non-transitory computer-readable memory, such as random-access memory (RAM), read-only memory (ROM), flash memory, or a combination thereof The modules can comprise processor-executable instructions that can be executed by processor 1005.

Wireless interface 1030 enables the PIU 305 to wirelessly communicate with components of the road marker system, such as the WIRMs 102, WIRM gateways 110, and/or the traffic management station 120. The wireless interface module 1022 can send data to and receive data from other components of the road marker system via the wireless interface 1030. The wireless interface module 922 can provide data received by the wireless interface 1030 to other modules in memory 1020 for processing and can receive data from the other modules to be transmitted to other components of the road marker system using wireless interface 1030. In some implementations, the PIU 305 can be configured to transmit a presence indicator signal to the WIRMs 102 proximate to the PIU 305.

The data processing module 1024 can be configured to control the timing and frequency of the transmission presence indicator signal, and can be configured to instruct the wireless data module 1022 to transmit the presence indicator signal. The data processing module 1024 can also be configured to receive data transmitted by one or more components of the road marker system, to analyze the data received, and to generate a response via the user interface module 1026 to alert a user of the PIU of an approaching road user or that the user is approaching a hazard of which the user should be made aware.

The user interface module 1026 can control one or more user interface component 1040 to provide feedback and/or to display information to the user. For example, in one implementation of the PIU, the PIU can include an light emitting diode (LED) or other indicator that can provide a visual or audio indicator to the user of the PIU that the PIU is activated. The user interface module 1026 can also be configured to provide haptic feedback to the user by vibrating the PIU if another road user is approaching the location of the road user that is using the PIU to identify his or her location on the roadway.

FIG. 11 is a block diagram of a WIRM that can be used to implement the WIRMs 102 used in the systems and methods disclosed herein. The WIRM 102 includes a light-emitting element 208. The light-emitting element 208 can include components capable of emitting more than one color of light. The light-emitting element 208 can comprise one or more light emitting diodes and/or other type of light emitting components. For example, in the example illustrated in FIG. 11, the light-emitting element 208 includes a red light-emitting component 220, a yellow light-emitting component, and a green light-emitting component 250.

The WIRM 102 also includes a transmitter 204 and a receiver 206. The transmitter 204 allows the WIRM 102 to transmit wireless signals 209 to other WIRMs 102, the WIRM gateways 110, the traffic management station 120, and/or the WIRM transceiver 900 associated with a road user. The receiver 206 can receive wireless signals from other WIRMs 102, the WIRM gateways 110, the traffic management station 120, and/or a PIU 305 or the WIRM transceiver 900 associated with a road user.

The processor 202 can comprise one or more microprocessors configured to access memory 260. The processor 202 can read data from and write data to memory 260. The processor 202 can also read executable program code from memory 260 and execute the program code. For example, the program code can include code that, when executed by the processor 202, causes the processor to process wireless signals received by the receiver 206 and to execute a response to those signals, to send a command to the transmitter 204 to transmit a wireless signal to one or more other components of the road marker system, to process signals received form sensor 210, and/or to send a command to the light-emitting element to illuminate or turn off illumination. The commands to the light-emitting element 208 can include information regarding which color or colors should be illuminated and/or a flashing illumination pattern to be executed by the light-emitting element 208.

The WIRM 102 can include a solar panel 212 that can provide power to the WIRM 102 and/or can be used to charge an onboard battery (not shown) that can provide power to the WIRM 102 at night or in low light conditions where the solar panel 212 is not receiving enough light to power the WIRM 102.

The WIRM 102 can include one more sensors 210. For example, the sensor 210 can comprise an optical sensor, a vibration sensor, or pressure sensor that can be used to detect the presence of road users proximate to the WIRM 102. The sensor 210 can also be used to detect a fallen tree, a disabled vehicle, debris, or other obstacle on the road surface that could present a hazard to a road user.

The various illustrative logical blocks, modules, and algorithm stages described may be implemented as electronic hardware, computer software, or combinations of both. To clearly illustrate this interchangeability of hardware and software, various illustrative components, blocks, modules, and stages have been described above generally in terms of their functionality. Whether such functionality is implemented as hardware or software depends upon the design constraints imposed on the overall system. The described functionality can be implemented in varying ways. In addition, the grouping of functions within a module, block or stage is for ease of description. Specific functions can be moved from one module or block without departing from the disclosure.

The various illustrative logical blocks and modules described can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, multiple microprocessors, one or more microprocessors in conjunction with a DSP core, or any other such configuration.

The operations of a method or algorithm described may be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

Various changes and modifications could be made to the descriptions provided above without departing from the scope of the disclosure or the appended claims. For example, although elements may be described or claimed in the singular, the plural may be included. Additionally, all or portions of aspects and/or embodiments may be utilized with other aspects and/or embodiments.

What is claimed is:

1. A method for illuminating intelligent road markers to identify the presence of a road user comprising:
receiving a position identification message at a first intelligent road marker from a position identification unit associated with a road user indicating that the road user is present on the road;
selecting one or more intelligent road markers proximate to the road user in response to the position identification message; and
illuminating the selected one or more intelligent road markers to identify the presence of the road user on the road.

2. The method of claim 1, further comprising:
determining a direction of travel of the road user; and
identifying one or more intelligent road markers in the direction of travel of the road user and one or more intelligent road markers behind the road user; and
wherein selecting one or more intelligent road markers proximate to the road user in response to the position identification message further comprises:
selecting at least one of the one or more intelligent road markers in the direction of travel of the road user; and
selecting at least one of the one or more intelligent road markers behind the road user.

3. The method of claim 2 further comprising:
determining a rate of travel of the road user; and
wherein identifying one or more road markers in the direction of travel of the road user and one or more intelligent road markers behind the road user further comprises:
determining an illumination distance from the road user based on the rate of travel of the road user; and
selecting intelligent road markers to be illuminated based on the illumination distance.

4. The method of claim 1 wherein the road user is a first road user and illuminating the selected one or more intelligent road markers proximate to the first road user is performed only if a second road user is detected within a predetermined distance of the first road user.

5. The method of claim 7, further comprising:
detecting the presence of the second road user comprises optically detecting the presence of the second road user.

6. The method of claim 7, further comprising:
detecting the presence of the second road user comprises detecting vibration induced by the second road user.

7. The method of claim 4, further comprising:
detecting the presence of the second road user at a second intelligent road marker; and
transmitting a road user detected message from the second intelligent road marker to a plurality of intelligent road markers within a predetermined distance of the second intelligent road marker.

8. The method of claim 7 wherein the one or more intelligent road markers proximate to the first road user are illuminated if at least one of the one or more intelligent road markers proximate to the first road user receives the road user detected message.

9. A dynamic intelligent road marker safety zone system comprising:
a plurality of intelligent road markers deployed along a road surface, each of the intelligent road markers comprising:
an illumination component;
a wireless receiver, the wireless receiver being configured to receive a presence indicator signal from a presence indication unit, the presence indication message indicating the presence of a road user proximate to the intelligent road marker;
a controller configured to perform the operations of
selecting one or more intelligent road markers proximate to the road user in response to the position identification message; and
sending a control signal to the illumination component to illuminate in response to the presence indication message.

10. The system of claim 9, wherein the controller of each of the intelligent road markers are configured to perform operations of:
determining a direction of travel of the road user; and
identifying one or more intelligent road markers from the plurality of intelligent road markers that are located in the direction of travel of the road user and one or more road markers behind the direction of travel the road user;
wherein each of the plurality of intelligent road markers includes a wireless transmitter configured to transmit illumination command messages wirelessly;
wherein selecting one or more intelligent road markers proximate to the road user in response to the presence indicator signal further comprises
selecting at least one of the one or more intelligent road markers in the direction of travel of the road user, and
selecting at least one of the one or more intelligent road markers behind the road user.

11. The system of claim 9 wherein each of the intelligent road markers is configured to perform the operations of:
determining a rate of travel of the road user;
wherein identifying one or more road markers in the direction of travel of the road user and one or more intelligent road markers behind the road user further comprises:
determining an illumination distance from the road user based on the rate of travel of the road user; and
selecting intelligent road markers to be illuminated based on the illumination distance.

12. The system of claim 9 wherein the road user is a first road user and illuminating the selected one or more intelligent road markers proximate to the first road user is performed only if a second road user is detected within a predetermined distance of the first road user.

13. The system of claim 12 wherein the intelligent road markers include at least one sensor for detecting the presence of a road user that does not have a position identification unit associated with the user.

14. The system of claim 13 wherein the at least one sensor includes an optical sensor for detecting the presences of the road user.

15. The system of claim 13 wherein the at least one sensor includes a motion vibration sensor to detect the presence of the road user.

16. The system of claim 13 wherein a second intelligent road marker is configured to perform the operations of:
detecting the presence of the second road user at a second intelligent road marker; and
transmitting a road user detected message from the second intelligent road marker to a plurality of intelligent road markers within a predetermined distance of the second intelligent road marker.

17. The system of claim 12 wherein the one or more intelligent road markers proximate to the road user are illuminated if at least one of the one or more intelligent road markers proximate to the road user receives the road user detected message.

18. A dynamic intelligent road marker safety zone system comprising:
means for receiving a position identification message at a first intelligent road marker from a position identification unit associated with a road user;
means for selecting one or more intelligent road markers proximate to the road user in response to the position identification message; and
means for illuminating the selected one or more intelligent road markers to identify the presence of the road user on the road.

19. The system of claim 18, further comprising:
means for determining a direction of travel of the road user; and
means for identifying one or more intelligent road markers in the direction of travel of the road user and one or more intelligent road markers behind the road user;
wherein the means for selecting one or more intelligent road markers proximate to the road user in response to the position identification message further comprises:
means for selecting at least one of the one or more intelligent road markers in the direction of travel of the road user; and
means for selecting at least one of the one or more intelligent road markers behind the road user.

20. The system of claim 18 further comprising:
means for determining a rate of travel of the road user; and
wherein the means for identifying one or more road markers in the direction of travel of the road user and one or more intelligent road markers behind the road user further comprises:
means for determining an illumination distance from the road user based on the rate of travel of the road user; and
means for selecting intelligent road markers to be illuminated based on the illumination distance.

21. The system of claim 20 wherein the road user is a first road user and the means for illuminating the selected one or more intelligent road markers proximate to the first road user is illuminates the selected one or more intelligent road markers only if a second road user is detected within a predetermined distance of the first road user.

22. The system of claim 21 wherein the intelligent road markers include at least one means for detecting the presence of a road user that does not have a position identification unit associated with the road user.

23. The system of claim 22 wherein the means for detecting the presence of a road user that does not have a position identification unit associated with the road user includes means for optically detecting the presence of the road user.

24. The system of claim 22 wherein means for detecting the presence of a road user that does not have a position identification unit associated with the road user includes means for detecting the presence of the road user via vibrations created by the road user.

25. The system of claim 21, further comprising:
means for detecting the presence of the second road user at a second intelligent road marker; and
means for transmitting a road user detected message from the second intelligent road marker to a plurality of intelligent road markers within a predetermined distance of the second intelligent road marker.

26. A tangible machine-readable medium having stored thereon machine-executable instructions for illuminating intelligent road markers to identify the location of a road user, comprising:
code for receiving a position identification message at a first intelligent road marker from a position identification unit associated with a road user;
code for selecting one or more intelligent road markers proximate to the road user in response to the position identification message; and
code for illuminating the selected intelligent road markers to identify the location of the road user on the road.

27. The medium of claim 26, further comprising:
code for determining a direction of travel of the road user; and
code for identifying one or more intelligent road markers in the direction of travel of the road user and one or more intelligent road markers behind the road user;
wherein the code for selecting one or more intelligent road markers proximate to the road user in response to the position identification message further comprises:
code for selecting at least one of the one or more intelligent road markers in the direction of travel of the road user;
code for selecting at least one of the one or more intelligent road markers behind the road user.

28. The medium of claim 26 further comprising:
code for determining a rate of travel of the road user; and
wherein the code for identifying one or more road markers in the direction of travel of the road user and one or more intelligent road markers behind the road user further comprises:
code for determining an illumination distance from the road user based on the rate of travel of the road user; and
code for selecting intelligent road markers to be illuminated based on the illumination distance.

29. The medium of claim 26 wherein the road user is a first road user and the code for illuminating the selected one or more intelligent road markers proximate to the first road user includes code for illuminating the selected one or more intelligent road markers only if a second road user is detected within a predetermined distance of the first road user.

30. The medium of claim 29 further comprising code for detecting the presence of a road user using on signals from an optical sensor.

31. The medium of claim 29 further comprising code for detecting the presence of a road user using signals from a vibration sensor.

32. The medium of claim 29, further comprising:
code for detecting the presence of the second road user at a second intelligent road marker; and
code for transmitting a road user detected message from the second intelligent road marker to a plurality of intelligent road markers within a predetermined distance of the second intelligent road marker.
